(19) United States
(12) Patent Application Publication
(10) Pub. No.: US 2020/0108909 A1
(43) Pub. Date: Apr. 9, 2020

(54) AIRCRAFT LONGITUDINAL STABILITY

(71) Applicant: ASTIGAN LTD, Southhampton Hampshire (GB)

(72) Inventors: Andrew Charles ELSON, Southhampton Hampshire (GB); Douglas CAMERON, Southhampton Hampshire (GB); Christopher HORNZEE-JONES, Southhampton Hampshire (GB); Hilary COSTELLO, Southhampton Hampshire (GB)

(21) Appl. No.: 16/624,595

(22) PCT Filed: Jun. 20, 2018
(86) PCT No.: PCT/GB2018/051720

§ 371 Date: Dec. 19, 2019

(30) Foreign Application Priority Data
Jun. 21, 2017 (GB) 1709887.2

(51) Int. Cl. B64C 3/14; B64C 1/00; B64C 1/16; B64C 3/26; B64C 39/02

(52) U.S. Cl. CPC B64C 3/14; B64C 1/0009; B64C 1/16; B64C 2201/042; B64C 39/024; B64C 2201/021; B64C 3/26

(57) ABSTRACT

An aircraft (1) has at least one main wing (2) and at least one boom fuselage (3). The main wing has an aerofoil section having a leading edge (20), a trailing edge (21), a chord length extending between the leading edge and the trailing edge, a centre of lift (Lw), a flexural centre and a centre of mass. The centre of lift, the flexural centre and the centre of mass are located all within a region at most 4% of the chord length.

### FIELD OF THE INVENTION

The present invention relates to an aircraft, and especially though not exclusively to a solar powered unmanned aerial vehicle optimised for long duration flights in the stratosphere. The invention particularly relates to longitudinal stability of such an aircraft.

### BACKGROUND OF THE INVENTION

An unmanned aerial vehicle (UAV) may be adapted for extreme duration flights in the stratosphere.

Flight at stratospheric altitudes has the advantage that the stratosphere exhibits very stable atmospheric conditions, with wind strengths and turbulence levels at a minimum between altitudes of approximately 18 to 30 kilometres. Stable environmental conditions are preferable for a variety of applications such as mapping and surveillance, and may be advantageous as they can minimise the external load bearing requirements of the aircraft structure in flight.

Weight is a key issue for any aircraft designer and particularly for a UAV optimised for extreme duration flight, e.g. of several days, weeks or months.

WO 2014/013268 describes a solar powered UAV launched from a lighter-than-air carrier balloon at stratospheric altitudes. The UAV is prevented from entering its flight mode during ascent and so can be designed to minimise the external load bearing requirements of the aircraft structure during launch.

Optimising the design and aerodynamic performance of such an aircraft can lead to further weight savings, enabling greater payloads to be carried for even longer flight durations.

### SUMMARY OF THE INVENTION

A first aspect of the invention provides an aircraft comprising at least one main wing and at least one boom fuselage, wherein the main wing has an aerofoil section having a leading edge, a trailing edge, a chord length extending between the leading edge and the trailing edge, a centre of lift, a flexural centre, and a centre of mass, wherein the centre of lift, the flexural centre and the centre of mass are located all within a region at most 4% of the chord length.

A boom fuselage is an extended slender nacelle-like body which extends longitudinally from the main wing. In particular it may support one or more stabilizer surfaces of the aircraft.

The flexural centre of an aerofoil section is the point about which an applied transverse load produces only bending deflection and no twist at the section. The locus of flexural centres of aerofoil sections forming the wing defines a flexural axis, i.e. the line along which loads must be applied in order to produce only bending and no torsion of the wing at any position along the wing span.

The centre of lift of an aerofoil section is the locus at which a lifting force perpendicular to the freestream flow direction is generated as the aerofoil section moves relative to the freestream flow.

By positioning the centre of lift substantially adjacent to or at the flexural centre the lifting force produces substantially no torsion on the aerofoil section. The wing can therefore be designed with a particularly lightweight structure of low stiffness in the wing spanwise direction.

However, the centre of lift of an aerofoil section is generally not static and moves with changing angle of attack, unless the pitching moment coefficient of the aerofoil section is substantially zero. If the pitching moment coefficient of the aerofoil section is substantially zero, the centre of lift of the aerofoil section will be substantially adjacent to or at the aerodynamic centre of the aircraft for a straight wing.

The aircraft has one or more boom fuselages which generate only a small amount of lift and therefore only a small pitching moment about the aerodynamic centre of the aircraft. The lift generated by each boom fuselage may be approximately zero.

By positioning the centre of lift close to the centre of mass the longitudinal static stability is easily ensured with only a moderate stabilizer force (e.g. from a tailplane surface), which reduces the bending load on the boom fuselage(s), so the boom fuselage may therefore also be designed with a particularly lightweight structure.

Therefore, by positioning the centre of lift, the flexural centre and the centre of mass all within a region at most 4% of the chord length, the aircraft may be designed with a particularly lightweight main wing and boom fuselage(s). Such an aircraft is ideally suited for extreme duration unmanned flights in the stratosphere with significant payload. This positioning also has beneficial aeroelastic effects for the wing to prevent flutter and divergence.

Positioning the centre of lift, the flexural centre and the centre of mass all within a region at most 4% of the chord length is a condition that may be satisfied for only some but preferably all of the sections of the main wing. The aircraft may have a straight or swept wing, For a straight wing (i.e. zero ¼ chord sweep angle regardless of planform taper) this condition may not only be satisfied locally for each section of the wing, but also for the aircraft as a whole in which the centre of lift of the aircraft, the flexural centre of the main wing, and the centre of mass of the aircraft are located all within a region at most 4% of the mean chord length.

The centre of lift, the flexural centre and the centre of mass (at aircraft level or at wing section level) are preferably located all within a region between approximately 2% and approximately 3% of the chord length. This is facilitated by there being substantially no change in mass or movement of mass of the aircraft during flight. A conventionally fueled aircraft undergoes substantial change in mass and mass balance as the fuel is consumed, whereas a solar powered aircraft does not suffer change in mass or mass balance.

The centre of mass may be located at most 2%, and preferably at most 1%, of the chord length forward of the centre of lift. Positioning the centre of mass forward of the centre of lift improves the aircraft's longitudinal stability.

The aerofoil section may have a reflexed camber line—a so called ‘reflexed camber aerofoil’. A reflexed camber aerofoil has a camber line (the mean line between the top and bottom geometric surfaces of the aerofoil, which describes the curvature of the aerofoil) which curves upwardly near the trailing edge. The ‘reflexed camber aerofoil may be arranged to provide a pitching moment of approximately zero (about the aerodynamic centre). For example, the reflexed camber aerofoil may have an upper geometric surface which has a positive curvature adjacent the leading edge and approximately zero curvature adjacent the trailing edge and no negative curvature between the leading edge and the trailing edge.

The main wing preferably has no moveable flight control surfaces. This reduces wing weight and flight control may be achieved through movable stabilizer surfaces or portions thereof. For example, at least one flight control surface may be attached to the aft end of the boom fuselage. The flight control surfaces may include rudder, elevator or ruddervator control surfaces for example. These may be incorporated in horizontal and vertical stabilizer surfaces, or in combined longitudinal-directional stabilizers (e.g. V-tail). The stabilizers may be all-moving flight control surfaces, or may be fixed and have movable flight control surfaces attached thereto. Having no moveable flight control surfaces or actuation on the main wing may improve aircraft reliability.

The aircraft may have at least two of the boom fuselages fixed to the main wing and extending rearwardly from the main wing. The main wing may have a central portion spanning between the booms, and outboard portions extending outwardly from the respective booms. The central portion may be substantially horizontal (no dihedral angle). The outboard portions may also be substantially horizontal or may form a dihedral or anhedral angle with the central portion. Alternatively, any portion of the main wing may be horizontal or have a dihedral or anhedral angle.

The boom fuselage(s) may extend forward of the main wing. This may assist with mass balance of tail mounted stabilizer surfaces.

At least one main propulsion motor may be mounted on the fuselage, or on the main wing. For example, a main propulsion motor may be mounted in the forward end of each boom fuselage. Each motor may be coupled to a propeller. The propeller may be arranged in a pusher or puller configuration. In the case there is more than one propeller, and the propellers are arranged on either side of the aircraft centreline, the propellers may be controllable to provide differential thrust. This may provide back up flight control in the event of partial or full loss of flight control surface function.

The aircraft may be solar powered. In particular the aircraft may be exclusively solar powered, i.e. without any other fuel carried on board the aircraft for propulsion purposes. Solar cells may be mounted in or on the main wing. The solar cells may extend substantially across the entire span of the main wing and occupy up to around 70% of the chord length. Alternatively the solar cells may extend across only a portion of the wing span and may occupy greater or less than 70% of the chord length.

The main wing may have a single spar at a spanwise section of the wing. The solar cells may extend substantially between the single spar and the wing trailing edge.

The main wing may be used to house a plurality of battery cells. At least some of the battery cells may be moveable to adjust the centre of mass of the aircraft. The adjustment may be carried out only whilst the aircraft is on the ground prior to launch, or alternatively the adjustment may be done whilst the aircraft is in the air.

The aircraft preferably is operable in the stratosphere. The aircraft may be adapted to sustain long duration flight in the stratosphere, i.e. continuous flights of several days, weeks or months.

The aircraft may carry a payload, and the total weight of the aircraft may be comprised of greater than 30% payload, preferably greater than 40% payload and more preferably greater than 50% payload. Payload may be defined as that portion of the mass of the aircraft that is not primarily used for propulsion and control of the aircraft. Payload may include data acquisition, storage and transmission equipment, and associated power supplies, for example.

The aircraft is preferably an unmanned vehicle. The vehicle may be remotely piloted or may be a fully autonomous vehicle.

The aircraft excluding any payload may have a mass of between 30 kg to 150 kg. The main wing may have a span of from 20 to 60 metres.

The aircraft preferably carries no landing gear during flight. Landing gear, or arrestor gear, is that portion of an aircraft which contacts the ground or water during landing and when the aircraft is stationary, e.g. ground contacting wheels, skis, skids, floats, etc. The absence of landing gear during flight reduces weight of the aircraft, and aids long endurance flight. The aircraft may be fitted with ground contacting elements when the aircraft is on the ground, and which fall away when the aircraft leaves the ground.

The aircraft may be incapable of horizontal take-off from the ground. For example the aircraft may rest on ground supports and be lifted vertically, e.g. by a lighter than air carrier, during ascent to a launch altitude.

The aircraft may be arranged to sustain only light aerodynamic loads, and hence have a particularly lightweight design. For example, the aircraft may be configured to withstand aerodynamic loads not exceeding 3 g. The aircraft may be prevented from entering a flight mode (i.e. wings generating lift to sustain flight) until after release from a lighter than air carrier at higher altitudes.

The aircraft may be configured to fly at a maximum operating limit speed, VMO, of 35 m/s to 50 m/s.

### BRIEF DESCRIPTION OF THE DRAWINGS

Embodiments of the invention will now be described with reference to the accompanying drawings, in which:

FIG. 1 illustrates a three-dimensional view of an aircraft;

FIGS. 2a and 2b illustrate section and plan views respectively of the main wing of the aircraft of FIG. 1;

FIG. 3 illustrates a schematic side view of the aircraft of FIG. 1; and

FIG. 4 illustrates a schematic section view through the main wing.

### DETAILED DESCRIPTION OF EMBODIMENT(S)

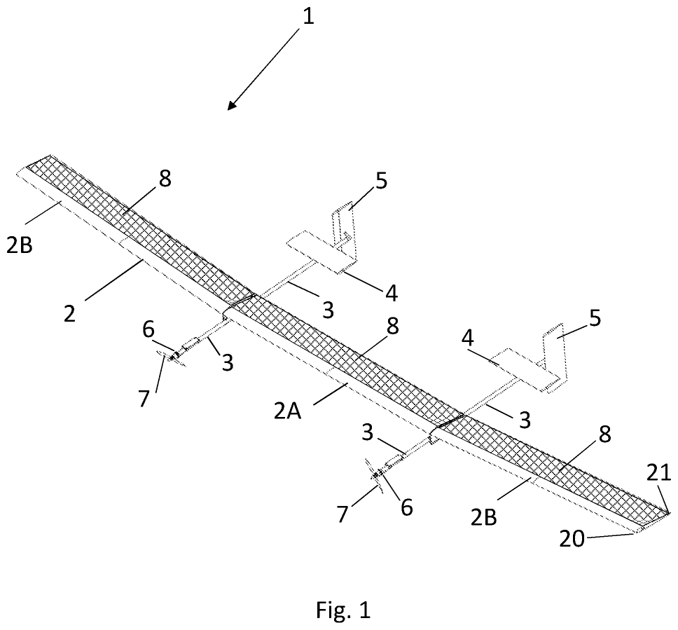

FIG. 1 illustrates an aircraft 1, which in this particular embodiment is an unmanned aerial vehicle comprising a main wing 2 and twin boom fuselages 3 each extending both forwardly and rearwardly of the main wing 2. The main wing 2 comprises a central portion 2A spanning between the boom fuselages 3, and outboard wing sections 2B each extending outboard from the respective boom fuselages 3. The central wing portion 2A is substantially horizontal, be has approximately zero dihedral angle, and the outboard wing sections 2B have a positive dihedral angle at approximately 5-10 degrees.

The aircraft 1 has, at the aft end of each boom fuselage 3, a horizontal stabilizer and a vertical stabilizer which in the illustrated embodiment are configured as all moving elevator 4 and all moving rudder 5 surfaces.

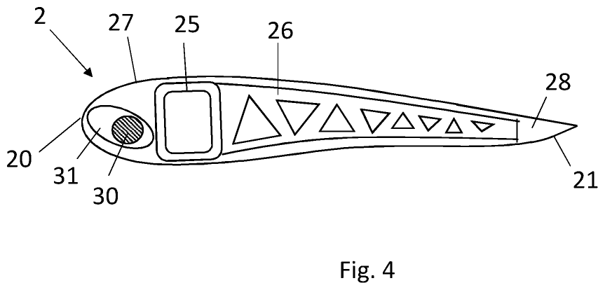

At the forward end of each boom fuselage 3 is mounted an electric motor 6 for driving a respective propeller 7. The main wing 2 carries an array of solar cells 8 extending substantially from tip to tip of the main wing 2 and extending approximately 70% of the wing chord. The main wing 2 has a leading edge 20 and a trailing edge 21. Just behind the wing leading edge 20 and contained within the wing section profile the aircraft 1 carries a plurality of rechargeable batteries for storing electrical energy converted by the solar array 8. The batteries will be described in greater detail with respective FIG. 4 below.

The aircraft 1 is designed for extreme duration flights in the Earth's stratosphere at altitudes of approximately 18 km to approximately 30 km above sea level. These flights may have a duration of several days, weeks or months made possible by charging the batteries 30 during daylight hours using the solar array 8 whilst at the same time discharging the batteries 30 to power the electric motors 6 for driving the propellers 7 which provide the main propulsion for the aircraft 1. During the night time when the solar array 8 is out of sunlight, the electrical energy stored in the batteries 30 is sufficient to continue supplying electrical power to the motors 6 for driving the propellers 7 throughout the night until the following day when the solar array 8 resumes converting incident solar energy into electrical energy. The batteries 30 may have a deep discharge cycle life of approximately 100 cycles, which would sustain flight for approximately 3 months. In alternative embodiments the batteries may be configured for a greater or lesser number of cycles, which may impact on the flight duration.

The aircraft 1 has no landing gear and is incapable of horizontal take-off from the ground. Instead, the aircraft 1 is adapted for launching at high altitude after being lofted by a lighter-than-air carrier such as a balloon, for example. Once released from the lighter-than-air carrier at altitude, the aircraft 1 accelerates and begins sustained flight using the propellers 7 to provide propulsion. The aircraft 1 is exclusively solar-powered in that it carries no fuel which is consumed during the flight as a propulsive energy source. Whilst the batteries 30 will generally be at least partially charged prior to launch, once the aircraft 1 begins sustained flight, the electrical energy used for recharging the batteries 30 is exclusively provided by the solar array 8.

The main wing 2 has a wing span of approximately 20-60 m and the aircraft 1, excluding any payload, has a mass of between 30 kg-150 kg. The aircraft is unmanned and may be either fully autonomous, or may be remotely piloted via a ground communication link.

The main wing 2 has no movable flight control surfaces. Pitch, yaw and roll control is provided primarily by the twin elevator 4 and rudder 5 movable flight control surfaces. The elevators 4 and rudders 5 are not mechanically linked but are typically controlled to move in unison by a flight controller. In some circumstances, the motors 6 driving the propellers 7 may be used to provide differential thrust. Differential thrust may be used to provide some level of yaw and roll control even in the event the primary flight control services, the elevators 4 and rudders 5, become inoperable or if their function is degraded. Increasing and decreasing the propeller speed may also be used to provide some level of pitch control, again in the event that the primary flight control surfaces, the elevators 4, become inoperable or if their function is degraded. With multiple boom fuselages and multiple tailplane surfaces, it is possible to use the tailplane surfaces in union, or differentially or in opposite directions. Use of the multiple tailplane surfaces differentially (i.e. similar flight control surfaces moved in the same direction but through differing angles) may provide roll control or flight control in a failure mode. Use of the multiple tailplane surfaces in opposite directions may provide air braking or spoiler action.

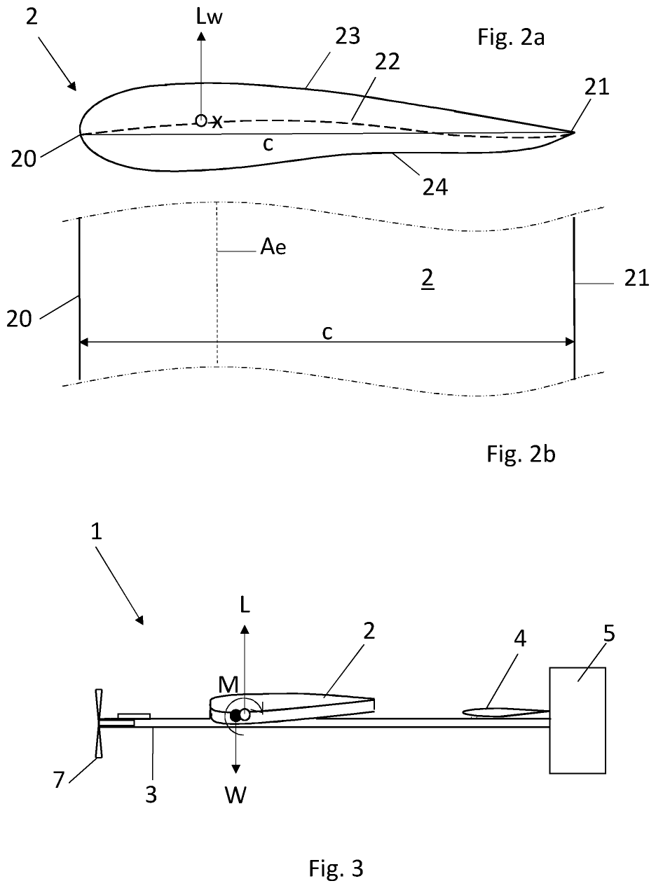

The main wing 2 has a reflexed camber aerofoil. FIG. 2a shows a section view of the aerofoil profile and FIG. 2b shows a partial span plan view of the main wing 2. The aerofoil has a chord, c, extending between the leading edge 20 and the trailing edge 21. In FIG. 2a, the broken line 22 illustrates the camber line of the aerofoil section. The camber line is the curve that is halfway between the upper and lower surfaces 23, 24 of the aerofoil.

The aerofoil is a so-called ‘reflexed camber aerofoil’, in that the camber line is curved upwardly adjacent the trailing edge 21. The upper surface 23 of the aerofoil has a positive curvature (convex) adjacent the leading edge 20 and approximately zero curvature adjacent the trailing edge 21 and no negative curvature (concave) between the leading edge and the trailing edge. The main wing 2 is of a stressed skin construction whereby a thin film is adhered or otherwise fixed to a wing structural framework, which will be described in detail with respect to FIG. 4 below.

Whilst a concave skin section is a common characteristic of many ‘reflexed camber aerofoils’, the aerofoil of the main wing 2 has no concave ‘negative curvature’ portions on the upper surface 23 as the tension in the stressed skin forming the upper surface 23 would otherwise have a tendency to pull itself off the supporting framework. To achieve the ‘reflexed camber aerofoil’ the thickness of the aerofoil section is maintained significantly further aft in the downstream chordwise direction than is conventional for ‘reflexed camber aerofoils’ resulting in a relatively thick aerofoil section up to approximately 80-90% chord measured from the leading edge, and then a relatively short taper to the trailing edge 21.

The flexural centre of the aerofoil is marked ‘x’ in FIG. 2a and is the point at which an applied torsion load produces only bending deflexion and no twist at the section. The locus of flexural centres of aerofoil sections forming the wing 2 defines the flexural axis, or elastic axis, Ae, which for the wing 2 is a straight line since the wing 2 is a straight wing with parallel leading and trailing edges perpendicular to the oncoming free stream airflow. The elastic axis, Ae is illustrated in the FIG. 2b.

Also illustrated in FIG. 2a is the centre of lift of the aerofoil section marked by the open circle, ‘o’. The centre of lift of the aerofoil section is the locus at which a lifting force perpendicular to the free stream flow direction is generated as the aerofoil section moves relative to the free stream flow. The centre of lift for an aerofoil section of a straight wing is the same as the centre of lift for the wing, Lw. By positioning the centre of lift substantially adjacent to the flexural centre, x, the lifting force produces substantially no torsion on the aerofoil section. The wing 2 can therefore be designed with a particularly lightweight structure of low stiffness in the wing spanwise direction.

Turning next to FIG. 3 which illustrates a schematic side view of the aircraft 1, the centre of gravity of the aircraft is illustrated by a shaded circle and at which the weight, W, of the aircraft acts; and the aerodynamic centre of the aircraft is illustrated by an open circle indicating the location at which the lift, L, of the aircraft 1 acts. The aircraft pitching moment, M, acts about the centre of mass.

The pitching moment coefficient of the aerofoil section is designed to be substantially zero and is made possible by use of the ‘reflexed camber aerofoil’ section. Since the pitching moment coefficient of the aerofoil section is substantially zero and the main wing 2 is a straight wing, the centre of lift of the aerofoil section will be substantially adjacent to or at the aerodynamic centre of the aircraft. As can be seen from FIG. 3, the location of the centre of mass and the location of the aerodynamic centre of the aircraft 1 are adjacent. More specifically, the centre of mass is approximately 1% of the wing chord length forward of the centre of lift (the aerodynamic centre).

Referring back to FIG. 2a, the centre of lift of the aerofoil section is substantially adjacent the elastic axis, Ae. Since the centre of lift of the aerofoil section and the centre of lift of the aircraft 1 are substantially coincident, it is possible to configure the aircraft 1 such that the centre of mass, the centre of lift and the elastic axis are all within approximately 2-3% of the chord length, c, of the wing 2 (both at wing section level and at aircraft level as the wing is straight and un-tapered). At most, the centre of lift, the centre of mass, the centre of lift and the flexural centre are located all within a region corresponding to 4% of the chord length, c, of the wing 2.

By positioning the centre of lift close to the centre of mass the longitudinal static stability of the aircraft 1 is easily ensured with only a moderate stabiliser force, which reduces the bending load on the boom fuselages 3, so the boom fuselages 3 may be designed with a particularly lightweight structure.

Furthermore, positioning the centre of lift substantially adjacent to or at the flexural centre, the wing 2 can be designed with a particularly lightweight structure of low stiffness in the wing spanwise direction. As a result, both the wing 2 and the boom fuselages 3 may be formed of a particularly lightweight construction which gives rise to the overall mass of the aircraft 1 (excluding payload) being from approximately 30 kg to approximately 150 kg for a wingspan for approximately 20 m to approximately 60 m. By driving weight out of the aircraft 1 the payload capacity of the aircraft can be increased. The total weight (i.e. aircraft+payload) may be comprised of approximately 30% to approximately 50% payload.

For high altitude, long endurance flights in the stratosphere the aircraft 1 may provide a particularly stable platform and may carry payloads suitable for mapping, surveillance, telecommunications or other operations. In particular, sensors, data acquisition and data transfer devices may be mounted in or on the aircraft 1 for missions that may be similar to those traditionally performed by satellites but at a fraction of the cost. The build and launch cost of the aircraft is much lower than for a satellite and the aircraft can also land for a mission change, but operating cost may be higher than that of a satellite due the need to constantly (remotely) pilot the aircraft. Currently full autonomy of such an aircraft is not permitted, however autonomy would provide lower operating cost for the aircraft if permitted in future.

Further detail of the aircraft wing structure is illustrated in FIG. 4 which is shown as a schematic cross section so as to illustrate a single main spar 25 and one of a plurality of ribs 26 spaced spanwise and each extending between a leading edge structure 27 and a trailing edge structure 28. Mounted within the leading edge structure 27 are the batteries 30 which extend substantially the entire span of the wing 2. The batteries 30 are movable within a slot 31 downwardly such that movement of the batteries fore and aft may be used for adjusting the mass balance of the aircraft wing and therefore of the aircraft as a whole. The slot 31 optionally is inclined rearwardly such that fore-aft movement of the batteries is accompanied by some vertical movement relative to the wing profile. The location of the batteries 30 may be adjusted prior to launching the aircraft 1 or alternatively may be movable during flight. So-called ‘pouch batteries’ may be used, which may be deformable or conformable so as to alter the mass location of battery prior to aircraft launch.

Although the invention has been described above with reference to one or more preferred embodiments, it will be appreciated that various changes or modifications may be made without departing from the scope of the invention as defined in the appended claims.

1. An aircraft comprising at least one main wing and at least one boom fuselage, wherein the main wing has an aerofoil section having a leading edge, a trailing edge, a chord length extending between the leading edge and the trailing edge, a centre of lift, a flexural centre, and a centre of mass, wherein the centre of lift, the flexural centre and the centre of mass are located all within a region at most 4% of the chord length.

2. An aircraft according to claim 1, wherein the centre of lift, the flexural centre and the centre of mass are located all within a region between approximately 2% and approximately 3% of the chord length.

3. An aircraft according to claim 1, wherein the centre of mass is located at most 1% of the chord length forward of the centre of lift.

4. An aircraft according to claim 1, wherein the aerofoil section has a reflexed camber line, preferably arranged to provide a pitching moment of approximately zero.

5. An aircraft according to claim 4, wherein the aerofoil has an upper geometric surface which has a positive curvature adjacent the leading edge and approximately zero curvature adjacent the trailing edge and no negative curvature between the leading edge and the trailing edge.

6. An aircraft according to claim 1, wherein the main wing has no moveable flight control surfaces.

7. An aircraft according to claim 1, further comprising at least one flight control surface attached to the aft end of the boom fuselage.

8. An aircraft according to claim 1, having at least two of the boom fuselages fixed to the main wing and extending rearwardly from the main wing.

9. An aircraft according to claim 8, wherein the main wing has a central portion spanning between the booms, and outboard portions extending outwardly from the respective booms.

10. An aircraft according to claim 9, wherein the central portion is substantially horizontal.

11. An aircraft according to claim 9, wherein the outboard portions are substantially horizontal or form a dihedral angle with the central portion.

12. An aircraft according to claim 1, wherein the boom fuselage(s) extend forward of the main wing.

13. An aircraft according to claim 1, further comprising at least one main propulsion motor mounted in the forward end of each boom fuselage.

14. An aircraft according to claim 13, wherein each motor is coupled to a propeller.

15. An aircraft according to claim 14, wherein the propellers are controllable to provide differential thrust.

16. An aircraft according to claim 1, which is solar powered.

17. An aircraft according to claim 16, wherein solar cells are mounted in the main wing.

18. An aircraft according to claim 17, wherein the solar cells extend substantially across the entire span of the main wing and occupy up to around 70% of the chord length.

19. An aircraft according to claim 1, wherein the main wing has a single spar.

20. An aircraft according to claims 17, wherein the main wing has a single spar, and wherein the solar cells extend substantially between the spar and the wing trailing edge.

21. An aircraft according to claim 1, wherein the main wing includes a plurality of battery cells.

22. An aircraft according to claim 21, wherein at least some of the battery cells are moveable to adjust the centre of mass of the aircraft.

23. An aircraft according to claim 1, operable in the stratosphere.

24. An aircraft according to claim 1, wherein the aircraft carries a payload and the total weight of the aircraft is comprised of greater than 30% payload, preferably greater than 40% payload and more preferably greater than 50% payload.

25. An aircraft according to claim 1, wherein the aircraft is an unmanned vehicle.

26. An aircraft according to claim 1, wherein the aircraft excluding any payload has a mass of between 30 kg to 150 kg.

27. An aircraft according to claim 1, wherein the main wing has a span of from 20 to 60 metres.

28. An aircraft according to claim 1, wherein the aircraft carries no landing gear during flight.

29. An aircraft according to claim 28, wherein the aircraft is incapable of horizontal take-off from the ground.

30. An aircraft according to claim 1, configured to withstand aerodynamic loads not exceeding 3 g.

31. An aircraft according to claim 1, configured to fly at a maximum operating limit speed, V_{MO}, of 35 m/s to 50 m/s.

32. An aircraft according to claim 1, and having an aircraft centre of mass and an aircraft centre of lift, wherein the main wing is a straight wing and wherein the flexural centre of the main wing, the aircraft centre of mass and the aircraft centre of lift are located all within a region at most 4% of the chord length.
